(19) United States
(12) Patent Application Publication
(10) Pub. No.: US 2008/0192346 A1
(43) Pub. Date: Aug. 14, 2008

(54) WIRE GRID POLARIZER AND METHOD OF FABRICATING THE SAME

(75) Inventors: Guk-hyun KIM, Yongin-si (KR); Su-mi LEE, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/925,254

(22) Filed: Oct. 26, 2007

(30) Foreign Application Priority Data
Feb. 13, 2007 (KR) 10-2007-0015100

(51) Int. Cl. G02B 5/30; B29D 11/00

(52) U.S. Cl. 359/486; 216/24

(57) ABSTRACT

Provided are a wire grid polarizer (WGP) and a method of fabricating the same. The WGP transmits first polarized light and reflects second polarized light among incident light, and includes at least one transparent dielectric layer; and a wire grid including a plurality of wires periodically arranged in the dielectric layer, each of the plurality of wires including a first region whose width gradually increases in a direction from the top of the wire grid to the bottom of the wire grid, and a second region whose width gradually decreases in a direction from the top of the wire grid to the bottom of the wire grid.

### CROSS-REFERENCE TO RELATED PATENT APPLICATION

This application claims priority from Korean Patent Application No. 10-2007-0015100, filed on Feb. 13, 2007, in the Korean Intellectual Property Office, the disclosure of which is incorporated herein in its entirety by reference.

### BACKGROUND OF THE INVENTION

1. Field of the Invention

Methods and apparatuses of the present invention relate to a wire grid polarizer (WGP), which transmits first polarized light and reflects second polarized light when unpolarized light is incident thereon, and a method of fabricating the wire grid polarizer.

2. Description of the Related Art

Wire grid polarizers (WGPs) are configured such that metal wires are periodically arranged in parallel to each other on a substrate. FIGS. 1A and 1B are respectively a perspective view and a cross-sectional view of a related art WGP, respectively. When the pitch of metal wires 15 of the related art WGP is less than the wavelength of incident light thereon, diffraction does not occur and thus the related art WGP can act as a polarizer. The related art WGP transmits a first polarized light whose electric field is perpendicular to the metal wires 15 and reflects a second polarized light whose electric field is parallel to the metal wires 15. The structure and operation of the related art WGP illustrated in FIGS. 1A and 1B are described in U.S. Pat. No. 6,243,199.

Since the WGP transmits the first polarized light and reflects the second polarized light, the WGP is mainly used in a projection display device. While the WGP, theoretically, transmits 100% of the first polarized light and reflects 100% of the second polarized light, in practice, the WGP reflects part of the first polarized light and transmits part of the second polarized light. When the transmittance of the first polarized light, the reflectance of the second polarized light, and the ratio of the transmittance of the first polarized light to the transmittance of the second polarized light are T, R, and CR, respectively, the transmittance T of the first polarized light and the reflectance R of the second polarized light are important factors in determining light use efficiency, and the ratio CR of the transmittance of the first polarized light to the transmittance of the second polarized light is an important factor in determining image quality, e.g., a contrast ratio. The higher the values of T, R, and Cr, the higher the display performance. In order to improve the light use efficiency of liquid crystal displays (LCDs), WGPs have recently been used as lower polarizing plates of the LCDs. An absorbing polarizing plate typically used in an LCD transmits one type of polarized light and absorbs other polarized light among unpolarized light emitted from a light source. Accordingly, at least half of the light is lost, thereby reducing light use efficiency. However, the WGP does not absorb polarized light, which does not need to be transmitted, but reflects the polarized light and then recycles the same again, thereby improving light use efficiency as compared with the absorbing polarizing plate. As in a projection display, the transmittance T and reflectance R are important factors in determining the light use efficiency of an LCD, and the ratio CR is an important factor in determining the image quality of the LCD. Accordingly, it is necessary that the values T and R are increased to improve the light use efficiency of the LCD, and the value Cr is increased to improve the image quality of the LCD.

Referring to FIG. 1A, the WGP includes a transparent substrate 10, and metal wires 15 arranged in parallel to each other on the transparent substrate 10. Air or a transparent low refractive index material may be filled between and over the metal wires 15. The cross-section of each of the metal wires 15 constituting the WGP and the effect of the cross-section of each of the metal wires 15 on the performance of the WGP will now be explained. However, the effects of the substrate 10, air, and the low refractive index material will not be considered. Accordingly, the following explanation will be made focusing on the effect of the cross-section of each of the metal wires 15 that are formed in one kind of transparent substrate. When the WGP illustrated in FIG. 1A is actually used for a system, it is preferable that the metal wires 15 of the WGP not be exposed to air in order to prevent the corrosion of the metal wires 15 having a fine linewidth and protect the metal wires 15 from physical impact.

The cross-sectional view of the WGP illustrated in FIG. 1B explains the operation of the WGP. When unpolarized light is incident on the WGP, first polarized light is transmitted through the wires 15 and second polarized light is reflected by the wires 15.

U.S. Pat. No. 6,243,199 describes the structure of a typical WGP operating in a visible light wavelength range. Referring to FIG. 1B, the WGP disclosed in U.S. Pat. No. 6,243,199 includes a wire grid having a rectangular cross-section. FIG. 2 illustrates metal wires 30 each having a rectangular cross-section surrounded by one kind of dielectric material 35. The pitch of the wire grid is p, the width of the metal wires 30 is w, the thickness of the metal wires 30 is t, and the angle of incident light is θ. Referring to FIG. 2, the metal wires 30 are formed of aluminum, and the refractive index of the dielectric material 35 is 1.5. Under the conditions of p=100 nm, w=50 nm, t=50˜250 nm, and θ=0°, when the wavelengths of incident light are 450 nm, 550 nm, and 650 nm, the transmittance T of first polarized light, the reflectance R of second polarized light, and the ratio CR of the transmittance of the first polarized light to the transmittance of the second polarized light are shown in the graphs of FIGS. 4, 5, and 6, respectively. The refractive index of the metal wires 30 is shown in Table 1.

TABLE 1

| | Real part of refractive | Imaginary part of refractive |
|---|---|---|
| Wavelength | index | index |
| 450 nm | 0.618 | 5.47 |
| 550 nm | 0.958 | 6.69 |
| 650 nm | 1.47 | 7.79 |

A plane on which the wire grid is disposed in FIG. 2 can be converted into an effective thin film structure in FIG. 3 by effective medium theory. According to the effective medium theory, when the pitch of the metal wires 30 of the wire grid is much less than the wavelength of incident light, the metal wires 30 and the dielectric material 35 are not discriminated, and behave as a uniform effective medium material. Accordingly, the layer on which the metal wires 30 are disposed in FIG. 2 can be converted into an effective thin film 50 formed of an effective material that is a composition of the metal wires 30 and the dielectric material 35 between the metal wires 30.

Upper and lower dielectric layers 51 are disposed above and below the effective thin film 50, such that a first interface 1b is formed between the effective thin film 50 and the upper dielectric layer and a second interface 2b is formed between the effective thin film 50 and the lower dielectric layer 51. In this thin film structure, transmission or reflection may be periodically varied according to the thickness of the effective thin film 50 due to a thin film effect or a Fabry-Perot etalon effect.

The transmittance T of the first polarized light is periodically varied according to the thickness t of the metal wires 30 due to the effective thin film 50 between the first interface 1b and the second interface 2b. Referring to FIG. 4, the transmittance T is varied with a pitch determined according to the wavelength of incident light. FIG. 5 illustrates the reflectance R of the second polarized light according to the thickness t of the metal wires 30. Referring to FIG. 5, the reflectance R is less affected by the thickness t. FIG. 6 illustrates the ratio CR of the transmittance of the first polarized light to the transmittance of the second polarized light according to the thickness t of the metal wires 30. Referring to FIG. 6, as the thickness t increases, the ratio CR increases.

In order to achieve a high transmittance T in an overall visible light wavelength range, that is, to achieve a high transmittance T for all the wavelengths of 450 nm, 550 nm, and 650 nm, the thickness t may be set to 120 nm. As a result, the performance of T>0.73, R>0.83, and CR>2500 can be achieved. In view of the graph of FIG. 6, a typical method of obtaining a higher value of CR is to increase the thickness t. However, since the transmittance T periodically varies in the wire grid having the rectangular cross-section, the ratio CR is increased but the transmittance T is decreased when the thickness t is increased. For example, when the thickness t is increased from 120 nm to 160 nm and the wavelength of incident light is 450 nm, the ratio CR is increased from 2500 to 30000, whereas the transmittance T is drastically decreased from 0.73 to 0.55. Accordingly, when the thickness t of the metal wires 30 is adjusted to achieve a high transmittance T, it is difficult to obtain a high ratio CR. That is, there is a limitation to satisfactorily increase both the transmittance T and the ratio CR.

In order to prevent the thin film effect, which is a drawback of the rectangular cross-section structure, U.S. Pat. No. 7,046,442 suggests a WGP including a wire grid having metal wires each having a triangular cross-section disposed on a substrate. FIG. 7 is a perspective view of a structure of the WGP disclosed in U.S. Pat. No. 7,046,442. Referring to FIG. 7, the WGP includes metal wires 63 each having a triangular cross-section disposed on a substrate 60. FIG. 8 illustrates the related art WGP including metal wires 73 having a triangular cross-section surrounded by a dielectric material 70. FIG. 9 illustrates a structure converted from the related art WGP of FIG. 8 using effective medium theory. Referring to FIG. 9, since the metal wires 73 having the triangular cross-section are configured such that the volume of metal increases from the top to the bottom of the metal wires 73 such that an upper interface “a” of an effective thin film 80 gets weak and only a lower interface “b” is formed, thereby forming a single interface structure. That is, since the density of metal is lower in the upper part of each of the metal wires 73 having the triangular cross-section, a clear interface with an upper dielectric layer 81 is not formed. However, since the metal density of the metal wires 73 having the triangular cross-section is higher in the lower part of each of the metal wires 73, a clear interface with a lower dielectric layer 81 is formed.

Under the conditions where the metal wires 73 of FIG. 8 are formed of aluminum, the refractive index of the peripheral dielectric material 70 is 1.5, p=100 nm, w=50 nm, t=150˜350 nm, and the angle θ of incident light of 0°, when the wavelengths of incident light are 450 nm, 550 nm, and 650 nm, T, R, CR, and the reflectance RP of the first polarization light are shown in the graphs of FIGS. 10, 11, 12, and 13, respectively. Here, the pitch of the wire grid is p, the width of the metal wires 73 is w, and the thickness of the metal wires 73 is t. Referring to FIG. 10, a thin film effect does not apply to the metal wire grid having the triangular cross-section, and thus the transmittance T is less varied than the transmittance T of FIG. 4. Accordingly, even though the thickness t is increased, the ratio CR can be increased without the loss of the transmittance T. For example, when the thickness t is increased from 230 nm to 290 nm, the transmittance T for the wavelength 450 nm of incident light is decreased from 0.76 to 0.75, whereas the ratio CR is significantly increased from 2800 to 26000.

However, there are still problems with such a triangular cross-sectional structure. Referring to FIG. 13, 5% of light, which needs to be transmitted, is unnecessarily reflected due to the single interface “b” illustrated in FIG. 9. If the 5% of light is not reflected but transmitted, the transmittance T can be improved. Furthermore, as the thickness t of the metal wires 73 is increased to increase the ratio CR, the metal wires 63 each having the triangular cross-section become sharper. As the metal wires 73 become sharper, the reflectance R of the second polarized light, which needs to be reflected, drops below 0.7 as shown in the graph of FIG. 1.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a wire grid polarizer that transmits a high proportion of a first polarized light, which needs to be transmitted, and reflects a high proportion of a second polarized light, which needs to be reflected, and can increase the ratio of the transmittance of the first polarized light to the transmittance of the second polarized light.

The present invention also provides a method of fabricating a wire grid polarizer including wires each having a cross-section whose width increases until it reaches a certain region and then decreases from the certain region.

According to an aspect of the present invention, there is provided a wire grid polarizer transmitting first polarized light and reflecting second polarized light among incident light, the wire grid polarizer comprising: at least one transparent dielectric layer; and a wire grid comprising a plurality of wires periodically arranged in parallel in the dielectric layer, each of the plurality of wires comprising a first region whose width gradually increases in a direction from the top of the wire grid to the bottom of the wire grid, and a second region whose width gradually decreases in a direction from the top of the wire grid to the bottom of the wire grid.

The wires may be entirely or partially buried in the dielectric layer.

Each of the first region and the second region may have a triangular shape.

The first region may have an isosceles triangular shape, and the second region may have an inverted isosceles triangular shape.

The first region may have a stepped profile, and the second region may have an inverted stepped profile.

The first region may have a right triangular shape, and the second region may have an inverted right triangular shape.

Each of the wires may have at least one cross-section selected from the group consisting of a diamond-shaped cross-section, a hexagonal cross-section, a circular cross-section, and an oval cross-section.

The first region may have a stepped profile, and the second region may have an inverted stepped profile.

Each of the wires may be formed of a metal selected from the group consisting of aluminum, gold, silver, and copper.

According to another aspect of the present invention, there is provided a method of fabricating a wire grid polarizer, the method comprising: coating a metal layer and a first mask layer on a substrate; forming a first pattern on the first mask layer; etching the first mask layer and the metal layer; coating a first dielectric layer on a part of the metal layer which remains after the etching; turning the resulting structure upside down so that the first dielectric layer is lowermost, and removing the substrate; coating a second mask layer on the metal layer, and forming a second pattern on the second mask layer; and etching the second mask layer and the metal layer.

The first pattern and the second pattern may be fabricated by nanoimprint lithography, laser interference lithography, or E-beam lithography.

Each of the first pattern and the second pattern may have a shape selected from a triangular shape, a semi-diamond shape, a semicircular shape, and a semi-oval shape, and each of the first pattern and the second pattern may have a stepped profile.

### BRIEF DESCRIPTION OF THE DRAWINGS

The above and other aspects of the present invention will become more apparent by describing in detail exemplary embodiments thereof with reference to the attached drawings in which:

FIG. 1A is a perspective view of a related art wire grid polarizer (WGP) having a rectangular cross-section;

FIG. 1B is a cross-sectional view of the WGP of FIG. 1A;

FIG. 2 is a cross-sectional view of a related art WGP configured such that wires each having a rectangular cross-section are surrounded by a dielectric material;

FIG. 3 illustrates a structure converted from the related art WGP of FIG. 2 using effective medium theory;

FIG. 4 is a graph illustrating the transmittance of a first polarized light according to the thickness of wires of the WGP of FIG. 2 for respective wavelengths of incident light;

FIG. 5 is a graph illustrating the reflectance of a second polarized light according to the thickness of the wires of the related art WGP of FIG. 2 for the respective wavelengths of the incident light;

FIG. 6 is a graph illustrating the ratio of the transmittance of the first polarized light to the transmittance of the second polarized light according to the thickness of the wires in the WGP of FIG. 2 for the respective wavelengths of the incident light;

FIG. 7 is a perspective view of a related art WGP including a wire grid comprising metal wires having a triangular cross-section;

FIG. 8 illustrates the related art WGP of FIG. 7 surrounded by a dielectric material;

FIG. 9 illustrates a structure converted from the related art WGP of FIG. 8 using effective medium theory;

FIG. 10 is a graph illustrating the transmittance of a first polarized light according to the thickness of wires of the WGP of FIG. 8 for wavelengths of incident light;

FIG. 11 is a graph illustrating the reflectance of a second polarized light according to the thickness of the wires of the WGP of FIG. 8 for respective wavelengths of incident light;

FIG. 12 is a graph illustrating the ratio of the transmittance of the first polarized light to the transmittance of the second polarized light according to the thickness of the wires in the WGP of FIG. 8 for the respective wavelengths of the incident light;

FIG. 13 is a graph illustrating the reflectance of the first polarized light according to the thickness of the wires of the WGP of FIG. 8 for the respective wavelengths of the incident light;

FIG. 14 is a cross-sectional view of a WGP according to an exemplary embodiment of the present invention;

FIG. 15 illustrates a structure converted from the WGP of FIG. 14 using effective medium theory;

FIG. 16 is a graph illustrating the transmittance of first polarized light according to the thickness of wires of the WGP of FIG. 14 for respective wavelengths of incident light;

FIG. 17 is a graph illustrating the reflectance of second polarized light according to the thickness of the wires of the WGP of FIG. 14 for the respective wavelengths of the incident light;

FIG. 18 is a graph illustrating the ratio of the transmittance of the first polarized light to the transmittance of the second polarized light according to the thickness of the wires of the WGP of FIG. 14 for the respective wavelengths of the incident light;

FIG. 19 is a graph illustrating the reflectance of the first polarized light according to the thickness of the wires of the WGP of FIG. 14 for the respective wavelengths of the incident light;

FIG. 20 illustrates a modification of the WGP of FIG. 14, according to another exemplary embodiment of the present invention;

FIG. 21 illustrates another modification of the WGP of FIG. 14, according to another exemplary embodiment of the present invention;

FIG. 22 illustrates a WGP according to another exemplary embodiment of the present invention;

FIG. 23 illustrates a WGP including wires having a hexagonal cross-section according to an exemplary embodiment of the present invention;

FIG. 24 illustrates a WGP including wires having an oval cross-section according to an exemplary embodiment of the present invention; and

FIG. 25A through FIG. 25G and FIG. 26 illustrate a method of fabricating a WGP according to an exemplary embodiment of the present invention.

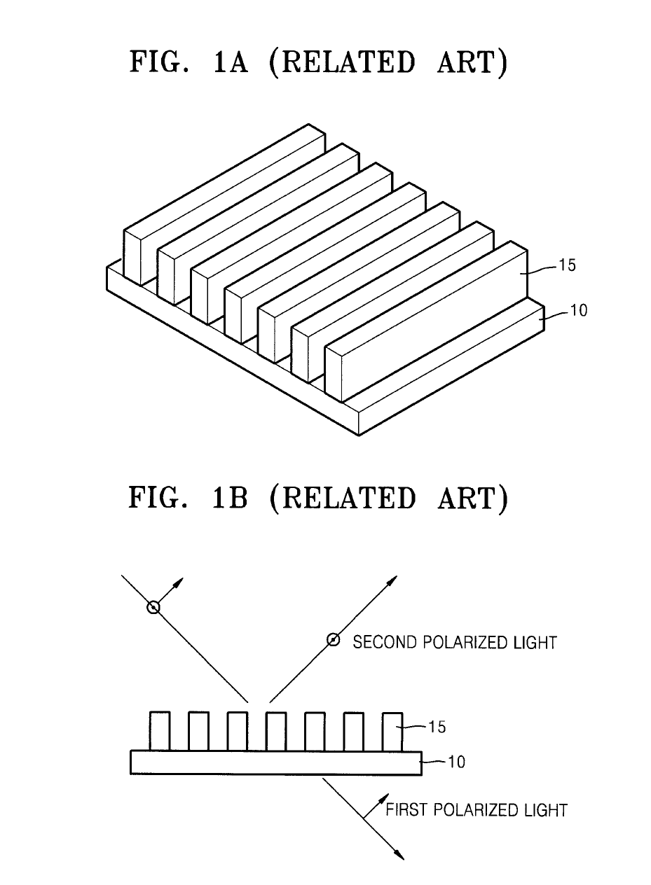

### DETAILED DESCRIPTION OF THE INVENTION

The present invention will now be described more fully with reference to the accompanying drawings, in which exemplary embodiments of the invention are shown.

A wire grid polarizer (WGP) according to the exemplary embodiment of the present invention, which transmits first polarized light whose electric field is perpendicular to wires and reflects second polarized light whose electric field is parallel to the wires of the WGP, can transmit a high proportion of the first polarized light and reflect a high proportion of the second polarized light, and can increase a ratio CR of the transmittance of the first polarized light to the transmittance of the second polarized light. To this end, the metal wires are arranged in parallel to one another with a pitch less than the wavelength of incident light in a transparent dielectric layer, wherein each of the metal wires has a first region whose width increases from the top to the bottom and a second region whose width decreases from the top to the bottom.

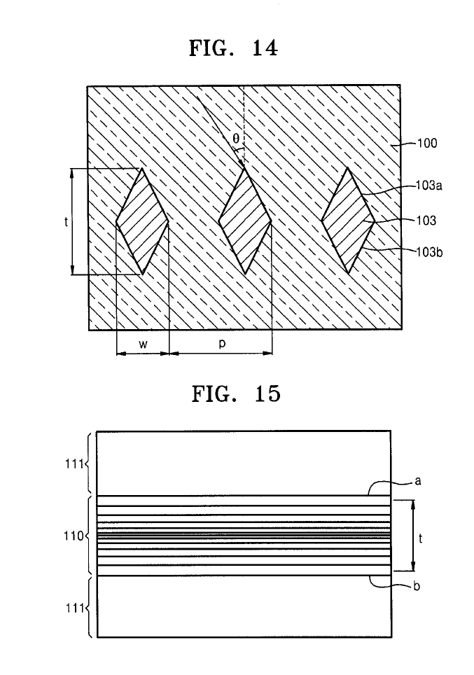

FIG. 14 is a cross-sectional view of a WGP according to an exemplary embodiment of the present invention. A grid of wires 103 are arranged in parallel to each other with a pitch less than the wavelength of incident light, wherein each of the grid of wires 103 has a cross-section including a first region 103a whose width increases in a direction from the top of the wire grid to the bottom of the wire grid, and a second region 103b whose width decreases in a direction from the top of the wire grid to the bottom of the wire grid. The increase or decrease in the width is continuous or discrete. Each of the wires 103 may be formed of a metal, for example, a metal selected from aluminum, gold, silver, and copper.

The first region 103a of each of the wires 103 may have any shape whose width increases from the top of the wire grid to the bottom of the wire grid, for example, a triangular shape. The triangular shape may be a shape selected from an equilateral triangular shape, an isosceles triangular shape, and a right triangular shape. Referring to FIG. 14, the first region 103a has an isosceles triangular shape according to the current exemplary embodiment of the present invention, and FIG. 21, to be described later, illustrates that a first region 143a has a right triangular shape.

The second region 103b of each of the wires 103 may have any shape whose width decreases from the top of the wire grid to the bottom of the wire grid, for example, an inverted triangular shape. The inverted triangular shape may be a shape selected from an inverted equilateral triangular shape, an inverted isosceles triangular shape, and an inverted right triangular shape. The first region 103a and the second region 103b may be symmetrical about a horizontal line.

The cross-section of the wires 103 may have a diamond shape. A dielectric layer 100 may be disposed around the wires 103. The dielectric layer 100 may be a single layer or a multi-layered structure. The wires 103 may be entirely or partially buried in the dielectric layer 100.

Referring to FIG. 14, the cross-section of the metal wires 103 may have a diamond shape including the first region 103a having an isosceles triangular cross-section and the second region having an inverted isosceles triangular cross section. The dielectric layer 100 is disposed around the wires 103. Here, the thickness of each of the wires 103 is t, the width of each of the wires 103 is w, the pitch of the wires 103 is p, and the angle of light incident on the wires 103 is θ.

FIG. 15 illustrates a structure converted from the WGP including the metal wires 103 having the diamond-shaped cross-section of FIG. 14 using effective medium theory. Referring to FIG. 15, a layer 110 on which the metal wires 103 are disposed has a central portion in which the density of metal is high and upper and lower portions in which the density of metal is low. The density of metal in the layer 110 on which the metal wires 103 are disposed is indicated by lines. Upper and lower dielectric layers 111 are disposed above and below the layer 110 on which the metal wires 103 are disposed. Effective interfaces are not formed at boundaries “a” and “b” between the upper and lower dielectric layers 111, respectively, and the layer 110 on which the metal wires 103 are disposed because the amount of space occupied by the metal wires 103 varies.

In other words, since the amount of space occupied by the metal wires 103 having the diamond-shaped cross-section gradually varies from the top to the bottom of the diamond-shaped cross-section, no effective interface is formed. Accordingly, a thin film effect, which makes it difficult to increase the ratio CR of a rectangular cross-section as described in the background of the invention with reference to the related art, is avoided. Reflection at a single interface of a triangular cross-section is also avoided, thereby decreasing reflectance RP and increasing transmittance T.

Since the diamond-shape cross-section according to the current exemplary embodiment of the present invention consists of two joined triangles, the wires 103 having the diamond-shaped cross-section are not as sharp as wires having a triangular cross-section when both the wires have the same thickness. Accordingly, a decrease in the reflectance R due to excessive sharpness can be avoided and the ratio CR can be increased.

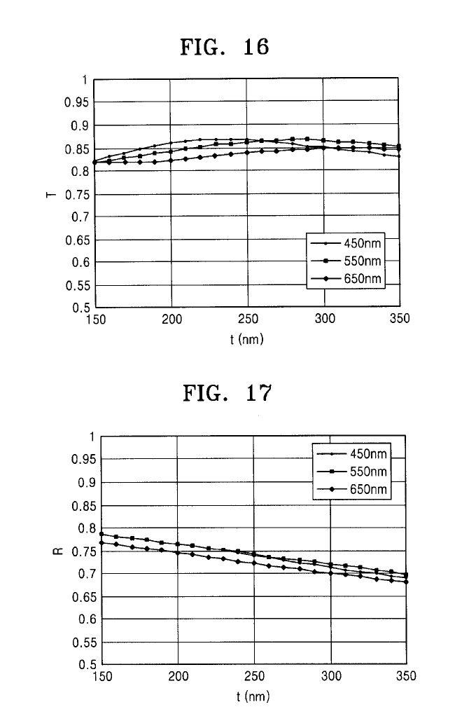

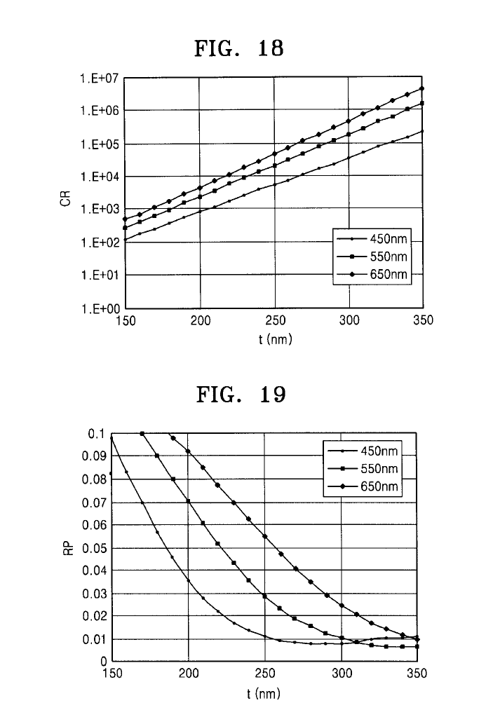

Under the conditions where the metal wires 103 are formed of aluminum, the dielectric layer 100 has a refractive index of 1.5, p=100 nm, w=50 nm, t=150˜350 nm, and θ=0°, when the wavelengths of incident light are 450 nm, 550 nm, and 650 nm, T, R, CR, and RP are shown in the graphs of FIGS. 16, 17, 18, and 19, respectively. FIG. 16 illustrates the transmittance T according to the thickness t. Referring to FIG. 16, the transmittance T does not vary much according to the change in thickness t. FIG. 17 illustrates the reflectance R according to the thickness t. Referring to FIG. 17, as the thickness t increases, the reflectance R decreases slightly. FIG. 18 illustrates the ratio CR according to the thickness t. Referring to FIG. 18, as the thickness t increases, the ratio CR increases. FIG. 19 illustrates the reflectance RP according to the thickness t. Referring to FIG. 19, as the thickness increases, the reflectance RP decreases.

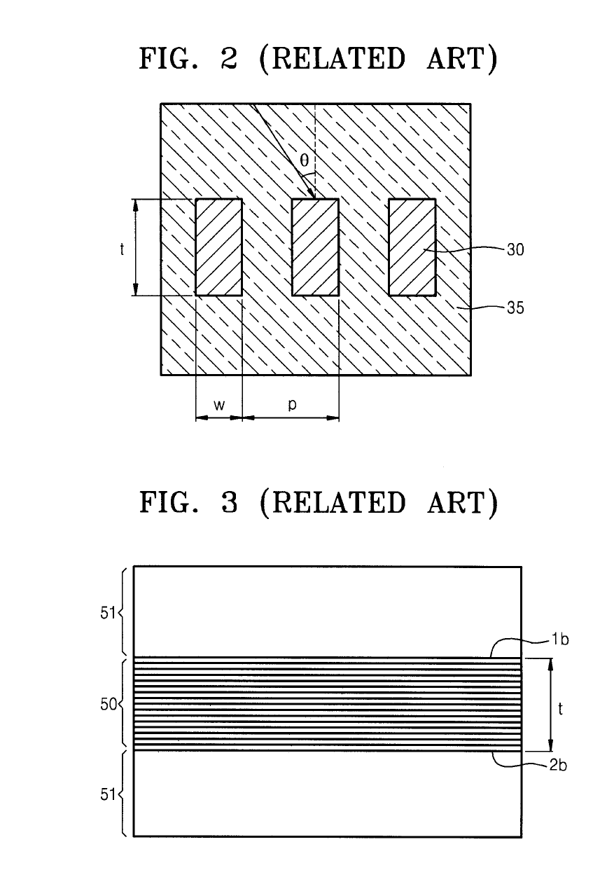

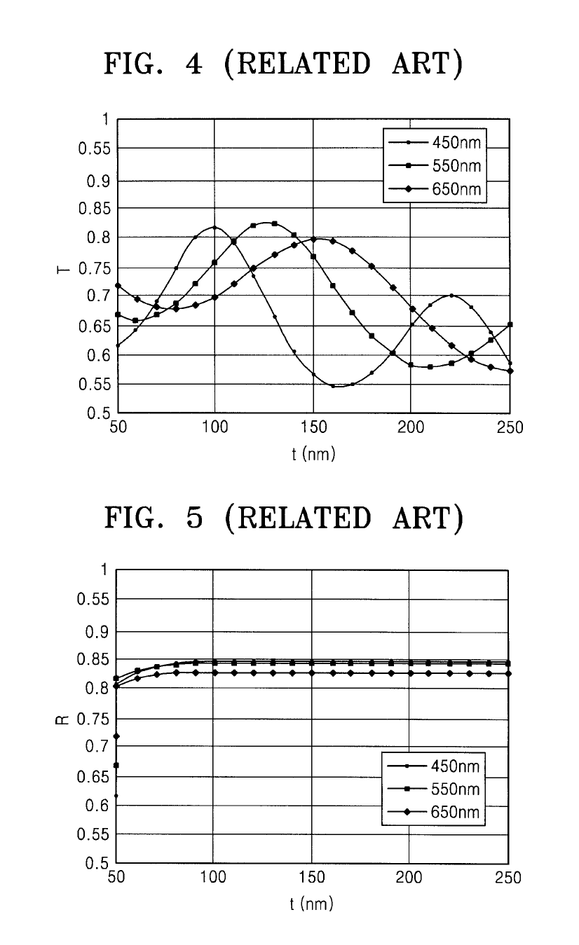

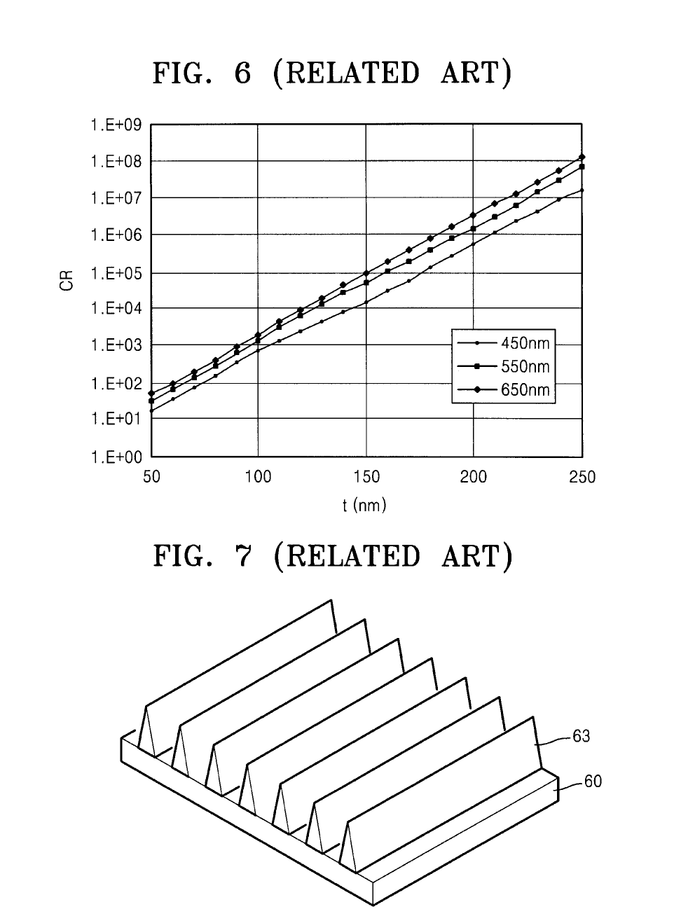

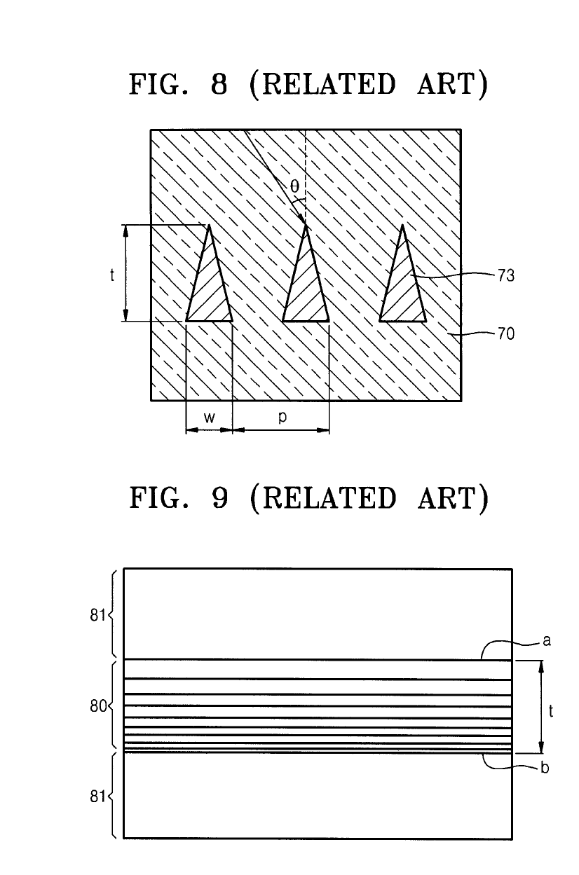

Referring to FIG. 16, the transmittance T does not vary much according to the change in thickness t, when compared with the transmittance T of the WGP of FIG. 2 shown in the graph of FIG. 4, because the diamond-shaped cross-section can prevent the thin film effect. Accordingly, while the transmittance T can be maintained high, the ratio CR can be increased by increasing the thickness t of the metal wires 103.

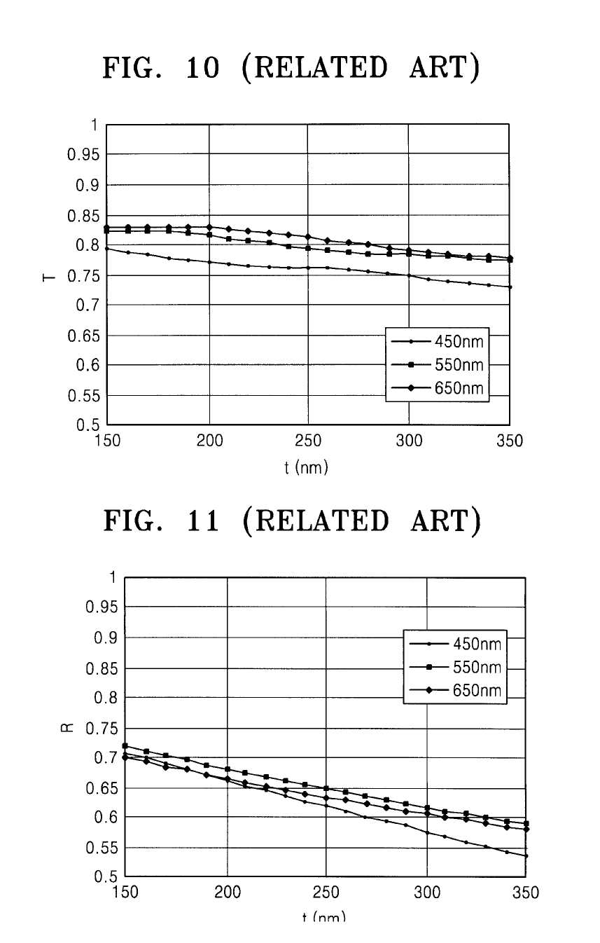

Reflection at a single interface cannot be observed by comparing a triangular cross-section having a thickness t of 150 nm and a diamond-shaped cross-section having a thickness t of 300 nm. Since the diamond-shaped cross-section consists of two joined triangles, when each of the wires 103 is formed of a metal, the diamond-shaped cross-section has twice as much volume of metal as the triangular cross-section. Nevertheless, since reflection at a single interface can be avoided, the reflectance RP of the diamond-shaped cross-section when the wavelength of incident light is 450 nm is 0.8% in FIG. 19, to be described later, which is lower than 8.4% that is the reflectance RP of the triangular-cross-section in FIG. 13. Also, the transmittance T of the diamond-shaped cross-section shown in the graph of FIG. 16 is 0.85, which is higher than 0.79, that is the transmittance T of the triangular cross-section shown in the graph of FIG. 10. Even when the wavelengths of incident light are 550 nm and 650 nm, reflection at a single interface can be prevented and thus the reflectance RP of the diamond-shaped cross-section can be decreased and the transmittance T of the diamond-shaped cross-section can be increased.

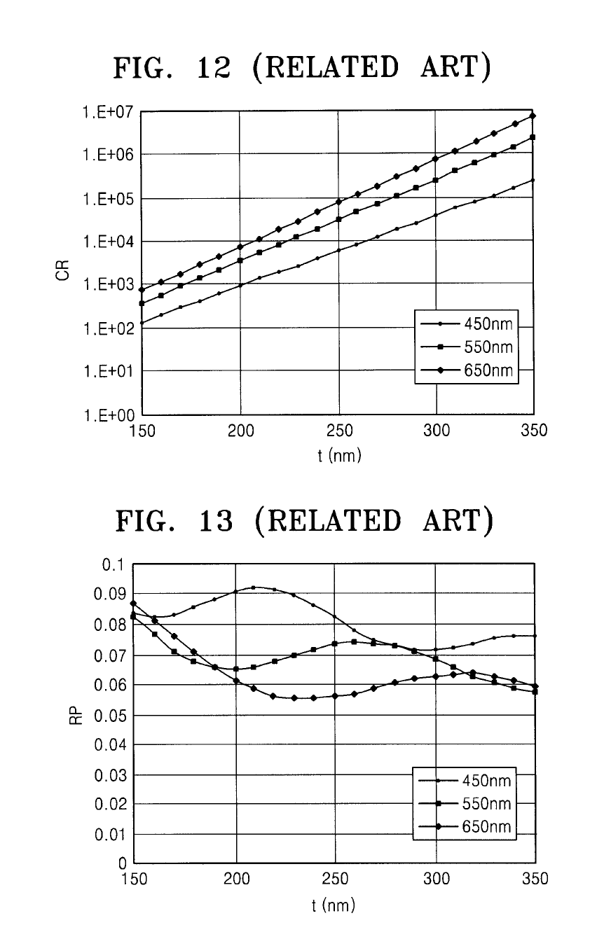

Since a triangular cross-section having a thickness t of 150 nm and a diamond-shaped cross-section having a thickness t of 300 nm have the same sharpness, when the wavelength of incident light is 450 nm, the reflectance R of both the triangular and the diamond-shaped cross-sections is 0.71 as shown in the graphs of FIGS. 11 and 17. However, since the diamond-shaped cross-section has twice the volume of metal as the triangular cross-section, when the wavelength of incident light is 450 nm, the ratio CR of the diamond-shaped cross-section is 36000, which is much higher than the ratio CR, that is 150, of the triangular cross-section, as shown in the graphs of FIGS. 12 and 18. Accordingly, the diamond-shaped cross-section can increase the ratio CR without decreasing the reflectance R due to excessive sharpness of the triangular cross-section.

For example, when the metal wires 103 of the WGP of FIG. 14 are formed of aluminum, the peripheral dielectric layer 100 has a refractive index of 1.5, p=100 nm, w=50 nm, t=290 nm, and θ=0°, the performance of T>0.84, R>0.70, and CR>25000 is achieved. On the contrary, when the metal wires 30 of the related art WGP having a rectangular cross-section of FIG. 2 are formed of aluminum, the peripheral dielectric material 35 has a refractive index of 1.5, p=100 nm, w=50 nm, t=120 nm, and θ=0°, the performance of T>0.73, R>0.83, CR>2500 is achieved. When compared, the transmittance T, the reflectance R, and the ratio CR of the WGP of FIG. 14 are increased by 11%, decreased by 13%, and increased by a factor of 10, respectively. That is, the transmittance T and the reflectance R of the WGP of FIG. 14 are similar to those of the WGP of FIG. 2, while the ratio CR of the WGP of FIG. 14 is 10 times greater than that of the WGP of FIG. 2.

The detailed values and refractive index of the WGP of FIG. 14 is an example of the superior performance of a WGP with metal wires having a diamond-shaped cross-section. The performance of a WGP with metal wires having a diamond-shaped cross-section can be improved through other combinations of the p, w, t, θ, metal, and peripheral dielectric layer.

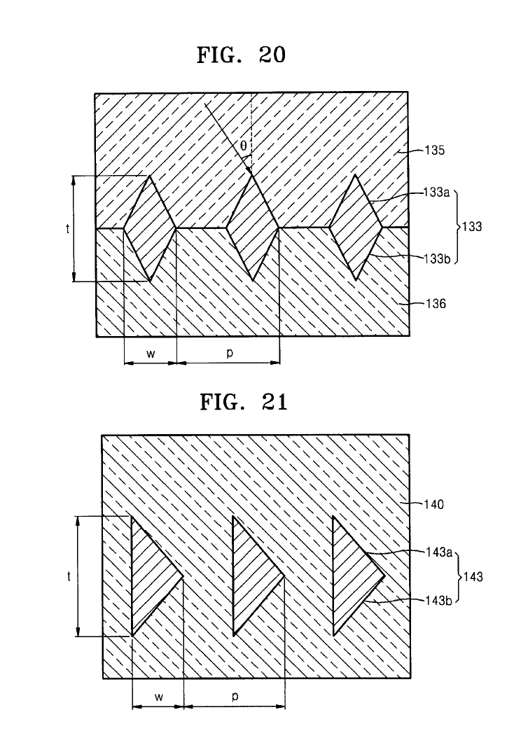

FIG. 20 illustrates a modification of the WGP of FIG. 14, according to another exemplary embodiment of the present invention. Referring to FIG. 20, a first region 133a of a diamond-shaped cross-section is surrounded by a first dielectric layer 135, and a second region 133b of the diamond-shaped cross-section is surrounded by a second dielectric layer 136. The first dielectric layer 135 may be air. Furthermore, each of the first and second dielectric layers 135 and 136 may be a single layer or a multi-layered structure, and metal wires may be entirely or partially buried in the dielectric layers.

As described above, a WGP with metal wires having a diamond-shaped cross-section has superior performance because the area of space occupied by the metal wires is gradually varied from the top of the wire grid to the bottom of the wire grid, and thus an effective interface is not formed. Such a principle may be applied not only to a diamond-shaped cross-section but also to a cross-section similar to a diamond-shaped cross-section. That is, any cross-section of metal wires, whose width gradually increases from a very low width at the top of the grid until it reaches a certain region and then decreases from the certain region to a very low width at the bottom of the grid can achieve relatively high transmittance T and reflectance, R, and a very high ratio CR based on the aforementioned principle.

FIG. 21 illustrates another modification of the WGP of FIG. 14, according to another exemplary embodiment of the present invention. Referring to FIG. 21, wires 143 having a right triangular first region 143a and an inverted right triangular second region 143b are surrounded by a dielectric layer 140. Since the cross-section of each of the wires 143 has a shape whose width gradually increases until it reaches a certain region and then decreases from the certain region and no effective interface is formed, similarly to a diamond-shaped cross-section, the cross-section of the wires 143 can achieve relatively high transmittance T and reflectance R, and a very high ratio CR.

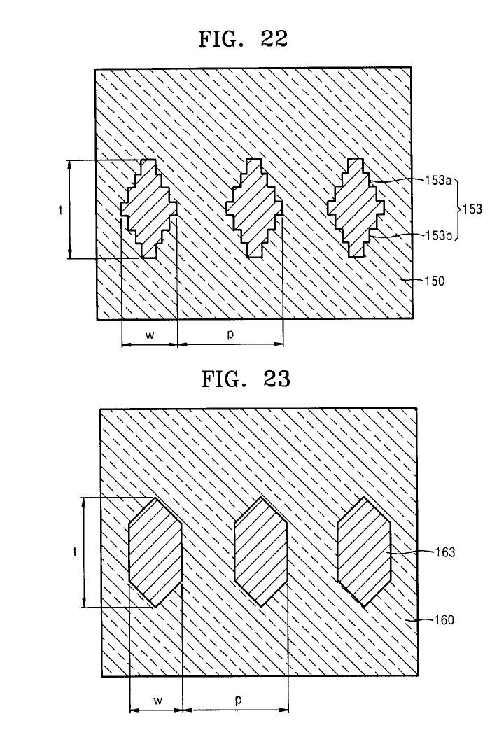

FIG. 22 illustrates a WGP according to another exemplary embodiment of the present invention. Referring to FIG. 22, each of wires 153 includes a first region 153a having a stepped profile whose width gradually increases from the top of the wire grid to the bottom of the wire grid, and a second region 153b having an inverted stepped profile whose width gradually decreases from the top of the wire grid to the bottom of the wire grid. Although the first region 153a and the second region 153b have stepped profiles, if the step width of the stepped profiles is much less than the wavelength of incident light, it is perceived by light that the width of the cross-section of each of the metal wires 153 gradually increases or decreases. A dielectric layer 150 is formed around the wires 153. The dielectric layer 150 may be a single layer or a multi-layered structure.

FIG. 23 illustrates a WGP with a wire grid having wires 163 which each have a hexagonal cross-section and are arranged in parallel to one another, according to an exemplary embodiment of the present invention. At least one dielectric layer 160 is formed around the wires 163.

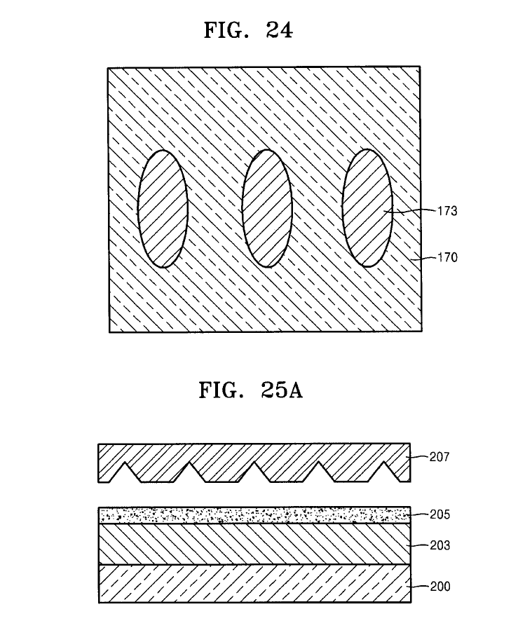

FIG. 24 illustrates a WGP with a wire grid having wires 173 which each have a circular or oval cross-section and are arranged in parallel to one another. At least one dielectric layer 170 is formed around the wires 173.

As described above, each of the WGPs according to the exemplary embodiment of the present invention has a wire grid with metal wires having a cross-section including a first region whose width gradually increases in a direction from the top of the wire grid to the bottom of the wire grid, and a second region whose width gradually decreases in a direction from the top of the wire grid to the bottom of the wire grid, thereby not forming an effective interface and increasing the transmittance T, the reflectance R, and the ratio CR of the WGP.

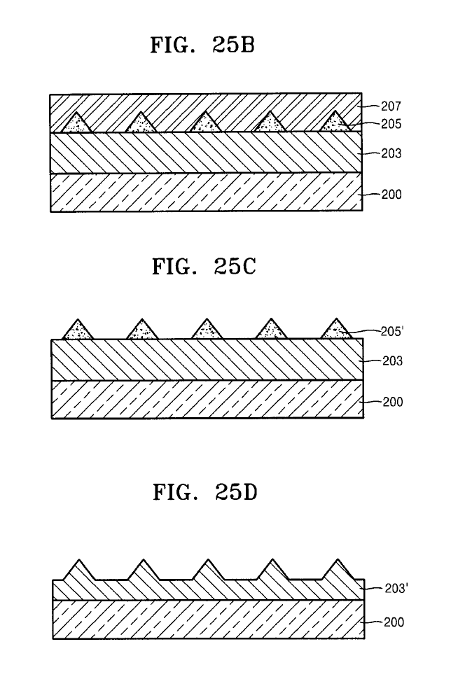

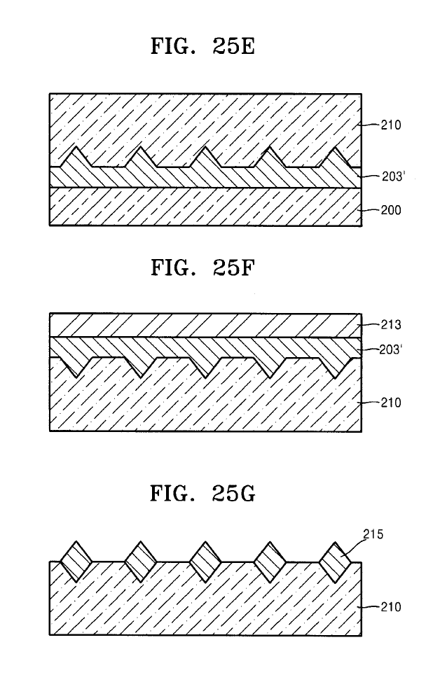

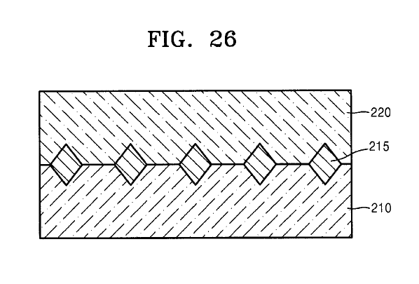

FIGS. 25A through 25G and 26 illustrate a method of fabricating a WGP according to an exemplary embodiment of the present invention.

The WGP may be fabricated by nanoimprint lithography, laser interference lithography, or E-beam lithography.

Referring to FIG. 25A, a metal layer 203 and a first mask layer 205 are coated on a substrate 200. Next, a mold 207 having a first pattern formed thereon is prepared. The first pattern may have a triangular, semi-diamond, semicircular, or semi-oval shape. Referring to FIG. 25B, the mold 207 is pressed onto the first mask layer 205. Referring to FIG. 25C, the first mask layer 205 is cured and then the mold 207 is separated from the first mask layer 205 to form a first mask pattern 205′ conforming to the first pattern. Instead of the imprint lithography using the mold 207, laser interference lithography or E-beam lithography may be used. That is, the first mask pattern 205′ may be formed in place of the first mask layer 205 using coherent laser beams or E-beams. Next, referring to FIG. 25D, the first mask pattern 205′ and the metal layer 203 are sequentially etched to form a metal pattern 203′ in place of the metal layer 203. Referring to FIG. 25E, a first dielectric layer 210 is coated on the first metal pattern 203′.

Next, referring to FIG. 25F, the resulting structure is turned upside down so that the first dielectric layer 210 is lowermost, the substrate 200 is removed, and a second mask layer 213 is coated on a surface of the first metal pattern 203′ opposite to that on which the first dielectric layer 210 is formed. Next, a second metal pattern 215 is formed in the same manner as the way in which the first metal pattern 203′ is formed using the first mask layer 205. A mold is pressed onto the second mask layer 213, the second mask layer 213 is cured, and the mold is removed. The second mask layer 213 and the metal pattern 203′ are etched to form a second metal pattern 215 in place of the metal pattern 203′. When the first mask pattern 205′ and the second metal pattern 215 are triangles, a WGP including wires having a diamond-shaped cross-section can be fabricated.

Two dielectric layers may be formed around the wires having the diamond-shaped cross-section. To this end, a second dielectric layer 220 is coated on the second mask pattern 215 as illustrated in FIG. 26. The second dielectric layer 220 may be formed of a material different from or the same as that of the first dielectric layer 210.

The WGP according to the exemplary embodiments of the present invention has a cross-section including a first region whose width gradually increases from the top to the bottom and a second region whose width gradually decreases from the top to the bottom, thereby not forming an effective interface. Accordingly, a thin film effect, which makes it difficult to increase the ratio CR of a rectangular cross-section, can be avoided. Reflection at a single interface, which is a problem of a triangular cross-section, is also avoided, thereby decreasing the reflectance RP and increasing the transmittance T. Additionally, since a diamond-shaped cross-section consists of two joined triangles, thick metal wires can be formed while a diamond-shaped cross-section is as sharp as a triangular cross-section. Accordingly, a decrease in the reflectance R due to excessive sharpness can be prevented and the ratio CR can be increased. As a result, when compared with a WGP having a rectangular cross-section, a WGP having a diamond-shaped cross-section can maintain the transmittance T and the reflectance R at a high level and greatly increase the ratio CR.

Moreover, in the method of fabricating a WGP according to the exemplary embodiments of the present invention, a WGP can be easily fabricated using nanoimprint lithography, laser interference lithography, or E-beam lithography.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wire grid polarizer transmitting first polarized light and reflecting second polarized light among incident light, the wire grid polarizer comprising:
at least one transparent dielectric layer; and
a wire grid comprising a plurality of wires periodically arranged in the dielectric layer, each of the plurality of wires comprising a first region whose width gradually increases in a direction from the top of the wire grid to the bottom of the wire grid and a second region whose width gradually decreases in a direction from the top of the wire grid to the bottom of the wire grid.

2. The wire grid polarizer of claim 1, wherein the plurality of wires are entirely or partially buried in the transparent dielectric layer.

3. The wire grid polarizer of claim 1, wherein each of the first region and the second region has a triangular shape.

4. The wire grid polarizer of claim 3, wherein the first region has an isosceles triangular shape, and the second region has an inverted isosceles triangular shape.

5. The wire grid polarizer of claim 4, wherein the first region has a stepped profile, and the second region has an inverted stepped profile.

6. The wire grid polarizer of claim 3, wherein the first region has a right triangular shape, and the second region has an inverted right triangular shape.

7. The wire grid polarizer of claim 1, wherein each of the plurality of wires has at least one cross-section selected from at least one of a diamond-shaped cross-section, a hexagonal cross-section, a circular cross-section, and an oval cross-section.

8. The wire grid polarizer of claim 1, wherein the first region has a stepped profile, and the second region has an inverted stepped profile.

9. The wire grid polarizer of claim 1, wherein each of the plurality of wires is formed of a metal.

10. The wire grid polarizer of claim 9, wherein the metal is at least one of aluminum, gold, silver, and copper.

11. The wire grid polarizer of claim 1, wherein the plurality of wires have a pitch less than the wavelength of incident light.

12. The wire grid polarizer of claim 1, wherein the incident light is visible light.

13. A method of fabricating a wire grid polarizer, the method comprising:
coating a metal layer and a first mask layer on a substrate;
forming a first pattern on the first mask layer;
etching the first mask layer and the metal layer;
coating a first dielectric layer on a part of the metal layer which remains after the etching;
turning the resulting structure upside down so that the first dielectric layer is lowermost, and removing the substrate;
coating a second mask layer on the metal layer, and forming a second pattern on the second mask layer; and
etching the second mask layer and the metal layer.

14. The method of claim 13, wherein the first pattern and the second pattern are fabricated by at least one of nanoimprint lithography, laser interference lithography, and E-beam lithography.

15. The method of claim 13, further comprising coating a second dielectric layer after the etching of the second mask layer.

16. The method of claim 13, wherein each of the first pattern and the second pattern has at least one of a triangular shape, a semi-diamond shape, a semicircular shape, and a semi-oval shape.

17. The method of claim 16, wherein each of the first pattern and the second pattern has a stepped profile.

18. The method of claim 13, wherein the metal layer is formed of a metal selected from aluminum, gold, silver, and copper.

19. The wire grid polarizer of claim 1, wherein the plurality of wires periodically arranged in the dielectric layer are arranged parallel to each other.
